(19) United States
(12) Patent Application Publication
(10) Pub. No.: US 2009/0278836 A1
(43) Pub. Date: Nov. 12, 2009

(54) METHOD OF DRIVING PLASMA DISPLAY PANEL

(76) Inventors: Moonshick Chung, Gumi-city (KR); Donghyuk Park, Gumi-city (KR); Choonsub Kim, Gumi-city (KR)

Correspondence Address: KED & ASSOCIATES, LLP, P.O. Box 221200, Chantilly, VA, 20153-1200, US

(21) Appl. No.: 12/435,118

(22) Filed: May 4, 2009

(30) Foreign Application Priority Data
May 9, 2008 (KR) 10-2008-0043457

(51) Int. Cl. G06F 3/038; G09G 3/28

(52) U.S. Cl. 345/213; 345/60

(57) ABSTRACT

A method of driving a plasma display panel is provided. The method includes supplying a data signal to at least one of a plurality of address electrodes during an address period of at least one subfield of a plurality of subfields, and supplying a first signal opposite a direction of the data signal to at least one of the plurality of address electrodes, to which the data signal will be supplied, during a reset period prior to the address period.

This application claims the benefit of Korea Patent Application No. filed on, the entire contents of which is incorporated herein by reference for all purposes as if fully set forth herein.

### BACKGROUND

1. Field

Embodiments relate to a method of driving a plasma display panel.

2. Description of the Background Art

A plasma display panel includes a phosphor layer inside discharge cells partitioned by barrier ribs and a plurality of electrodes.

When driving signals are applied to the electrodes of the plasma display panel, a discharge occurs inside the discharge cells. More specifically, when the discharge occurs in the discharge cells by applying the driving signals to the electrodes, a discharge gas filled in the discharge cells generates vacuum ultraviolet rays, which thereby cause phosphors between the barrier ribs to emit visible light. An image is displayed on the screen of the plasma display panel using the visible light.

In one aspect, there is a method of driving a plasma display panel including a plurality of scan electrodes, a plurality of sustain electrodes, and a plurality of address electrodes, the method comprising supplying a data signal to at least one of the plurality of address electrodes during an address period of at least one subfield of a plurality of subfields, and supplying a first signal opposite a direction of the data signal to at least one of the plurality of address electrodes, to which the data signal will be supplied, during a reset period prior to the address period.

In another aspect, there is a method of driving a plasma display panel including a plurality of scan electrodes, a plurality of sustain electrodes, and a plurality of address electrodes, the method comprising supplying scan signals to the plurality of scan electrodes during an address period of at least one subfield of a plurality of subfields, supplying second signals opposite a direction of the scan signals to the plurality of scan electrodes during a reset period prior to the address period, sequentially supplying the scan signals to two non-adjacent scan electrodes of the plurality of scan electrodes, and sequentially supplying the second signals to two non-adjacent scan electrodes of the plurality of scan electrodes.

In still another aspect, there is a method of driving a plasma display panel including a plurality of scan electrodes, a plurality of sustain electrodes, and a plurality of address electrodes, the method comprising supplying a scan signal to the plurality of scan electrodes and supplying a data signal corresponding to the scan signal to at least one of the plurality of address electrodes during an address period of at least one selective write subfield of a plurality of subfields of a frame, at least one of remaining subfields excluding the at least one selective write subfield from the plurality of subfields being a selective erase subfield, and supplying a first signal opposite a direction of the data signal to at least one of the plurality of address electrodes, to which the data signal will be supplied, and supplying a second signal opposite a direction of the scan signal to the plurality of scan electrodes during a reset period prior to the address period.

BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

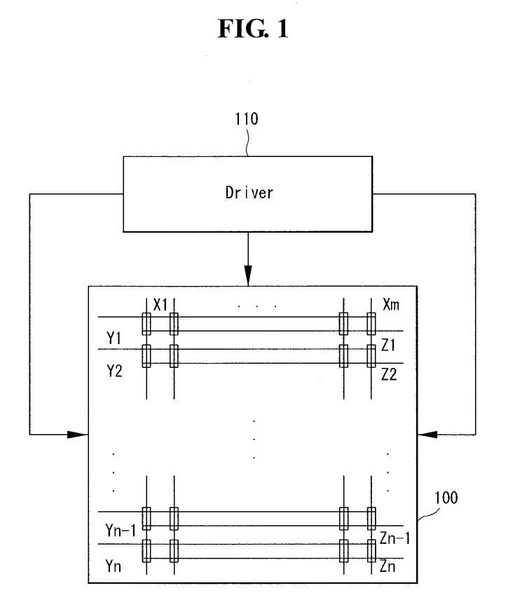

FIG. 1 illustrates an exemplary configuration of a plasma display apparatus according to an embodiment;

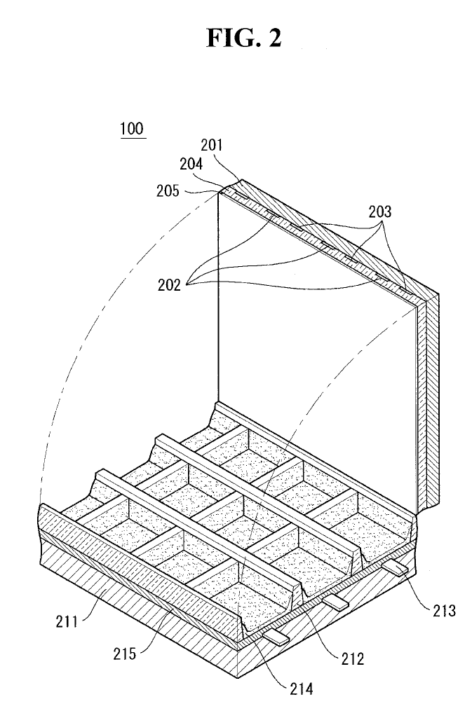

FIG. 2 illustrates an exemplary structure of a plasma display panel according to an embodiment;

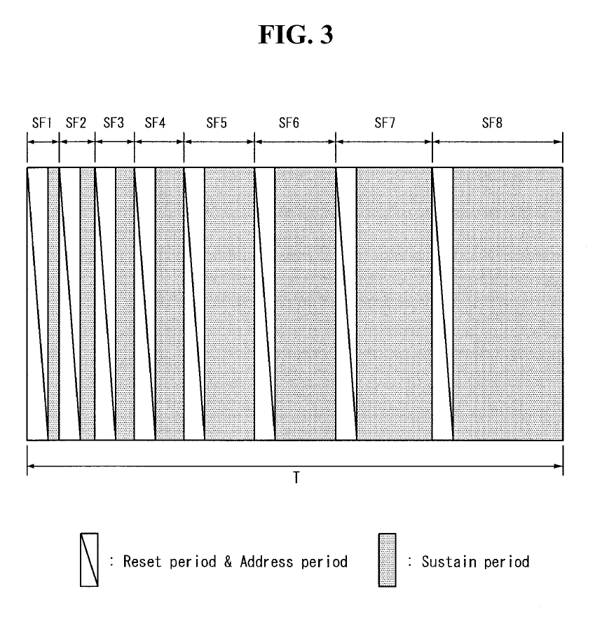

FIG. 3 illustrates a frame for achieving a gray level of an image;

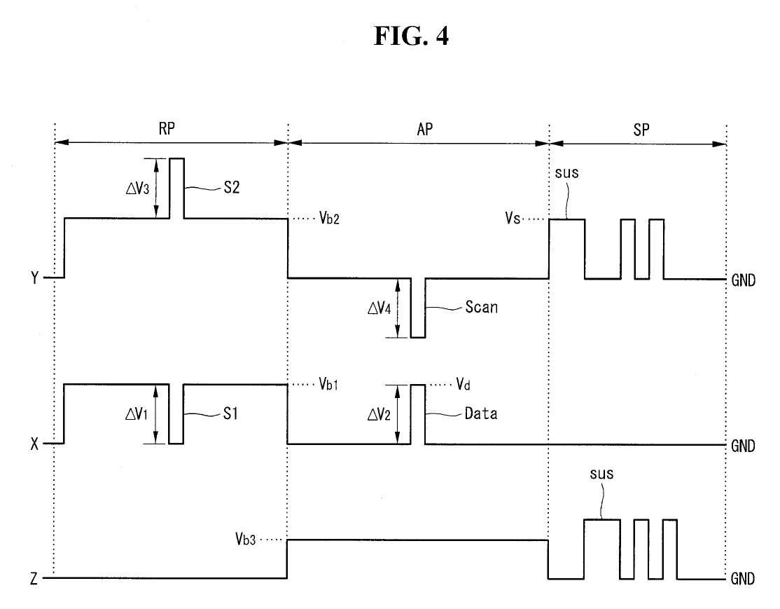

FIG. 4 illustrates an exemplary method for driving a plasma display panel according to an embodiment;

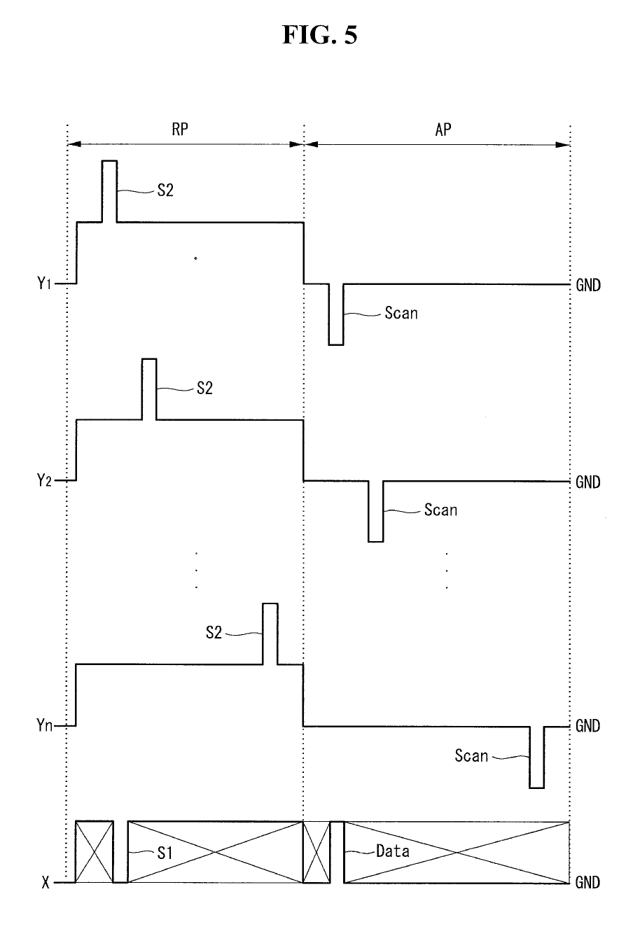

FIGS. 5 to 7 illustrate an exemplary method for driving the plasma display panel during a reset period;

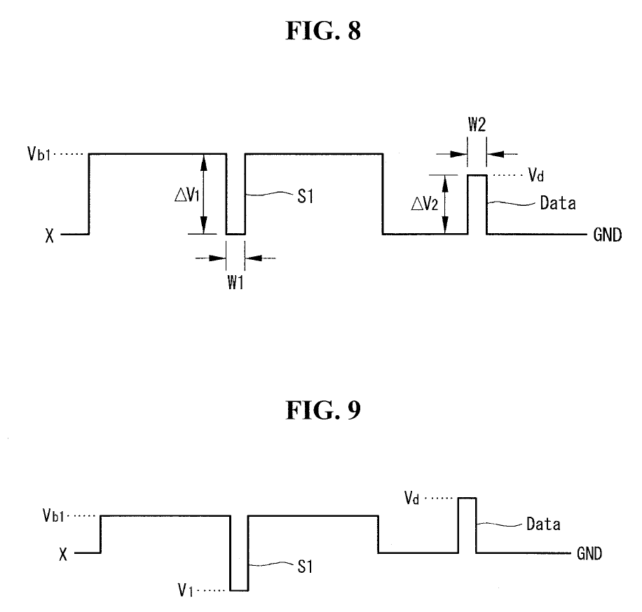

FIGS. 8 to 10 illustrate another form of a first signal;

FIGS. 11 to 13 illustrate another form of a second signal;

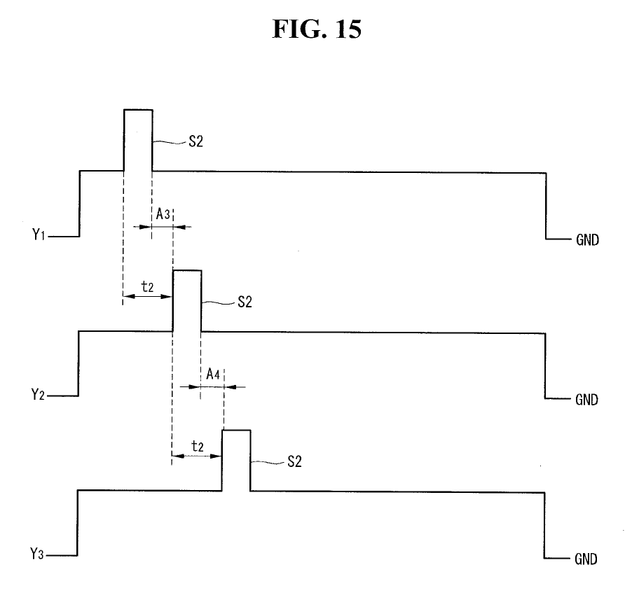

FIGS. 14 and 15 illustrate a relationship between two successively supplied second signals;

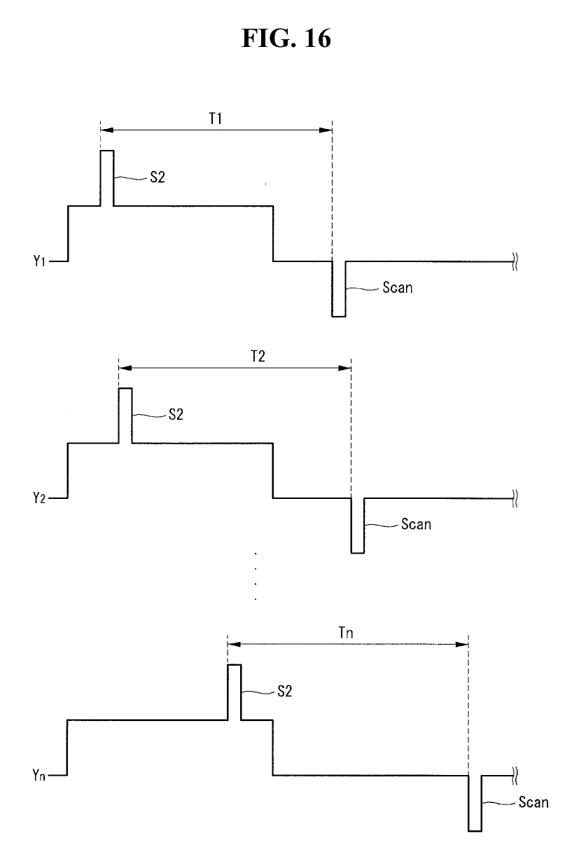

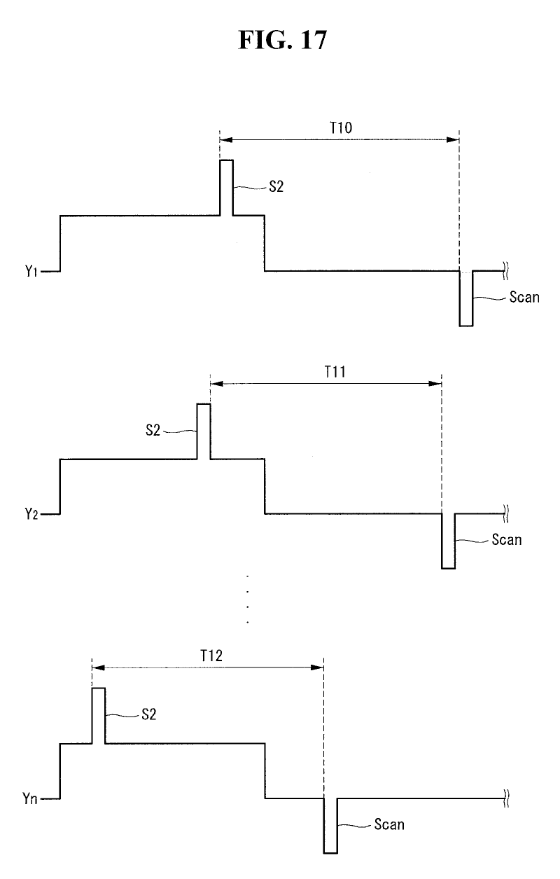

FIGS. 16 and 17 illustrate a relationship between a second signal and a scan signal;

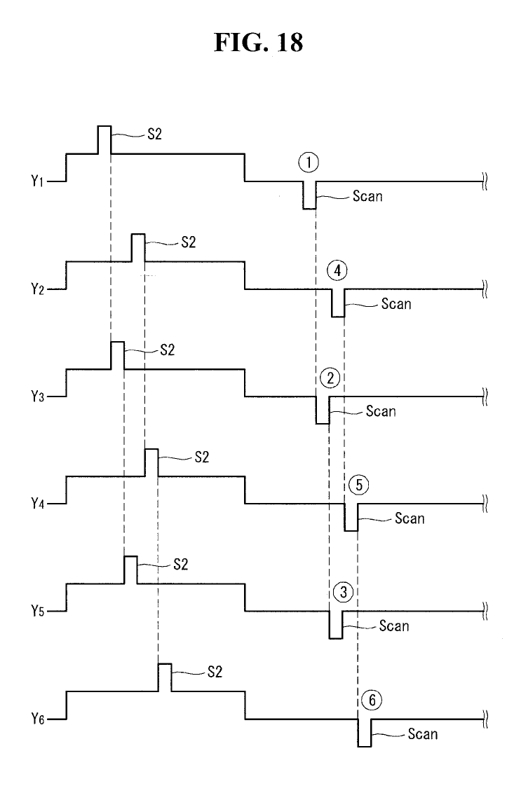

FIG. 18 illustrates an exemplary method for adjusting a supply order of a second signal;

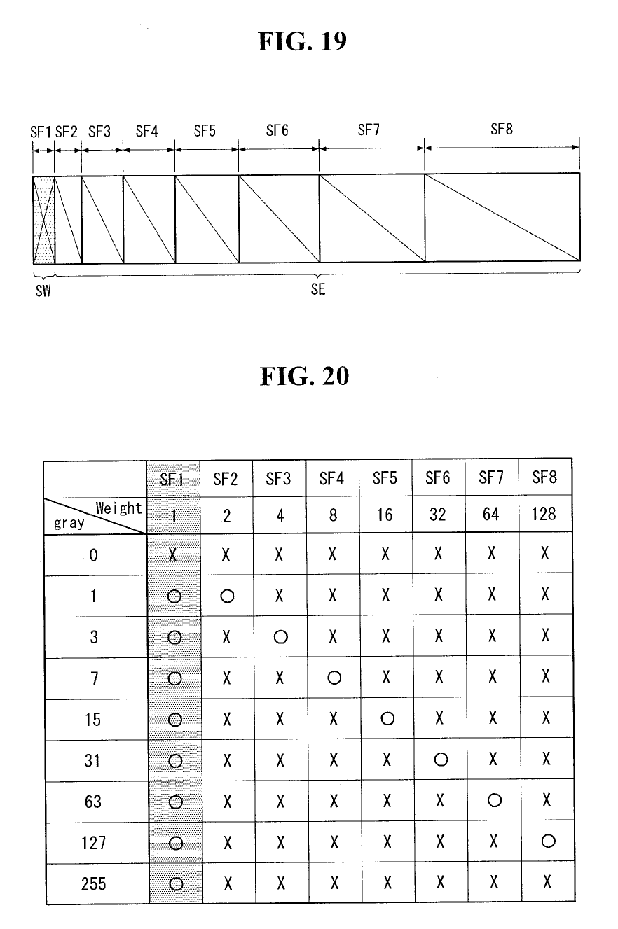

FIGS. 19 and 23 illustrate a selective write subfield and a selective erase subfield;

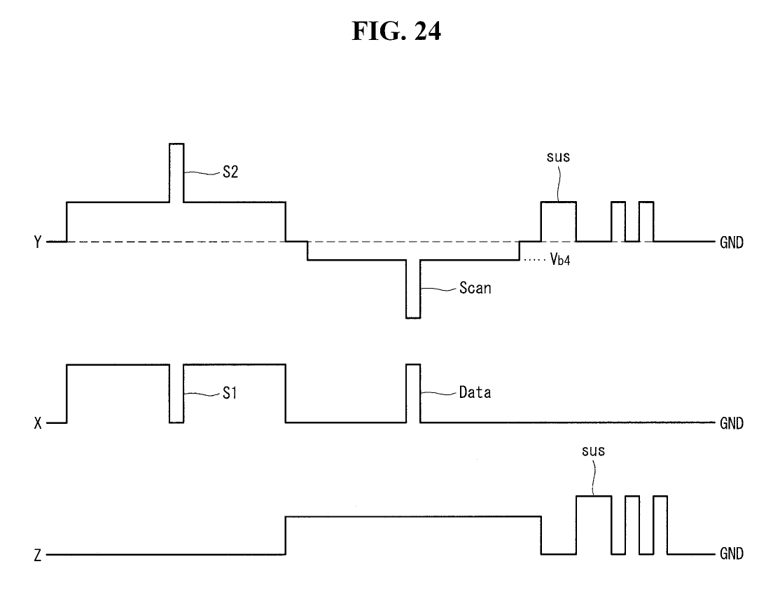

FIG. 24 illustrates a fourth bias voltage;

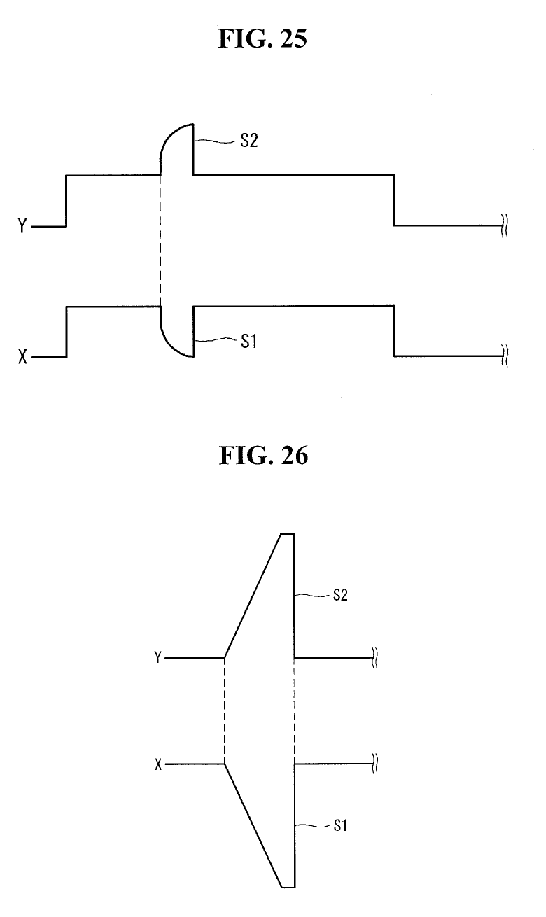

FIGS. 25 and 26 illustrate another form of first and second signals;

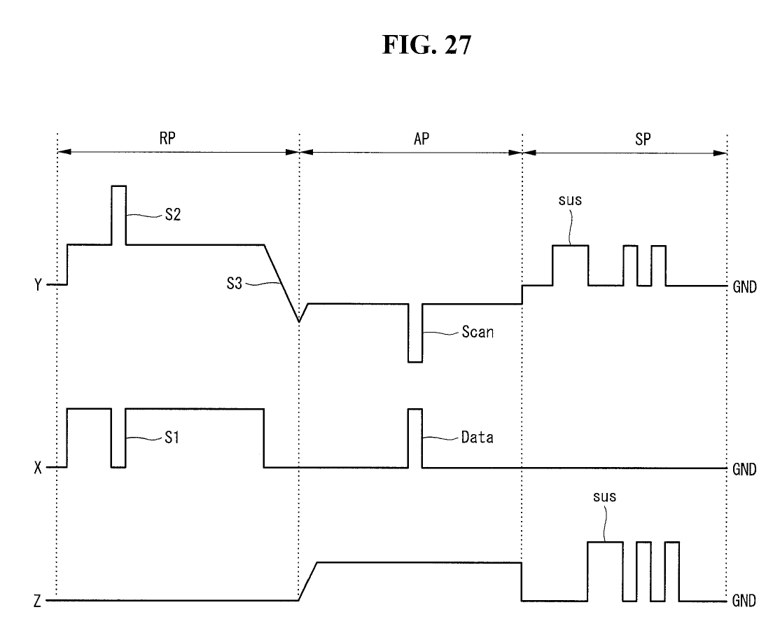

FIG. 27 illustrates a signal supplied between a reset period and an address period;

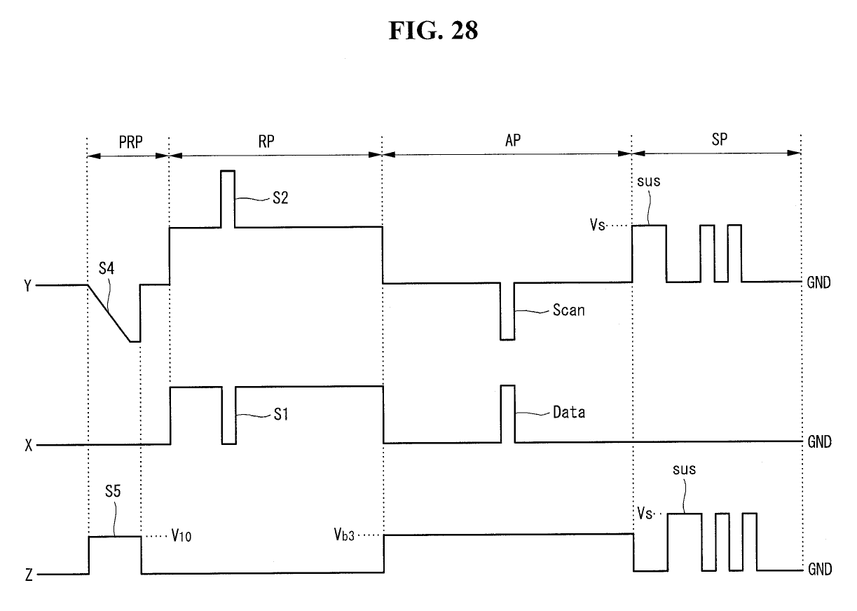

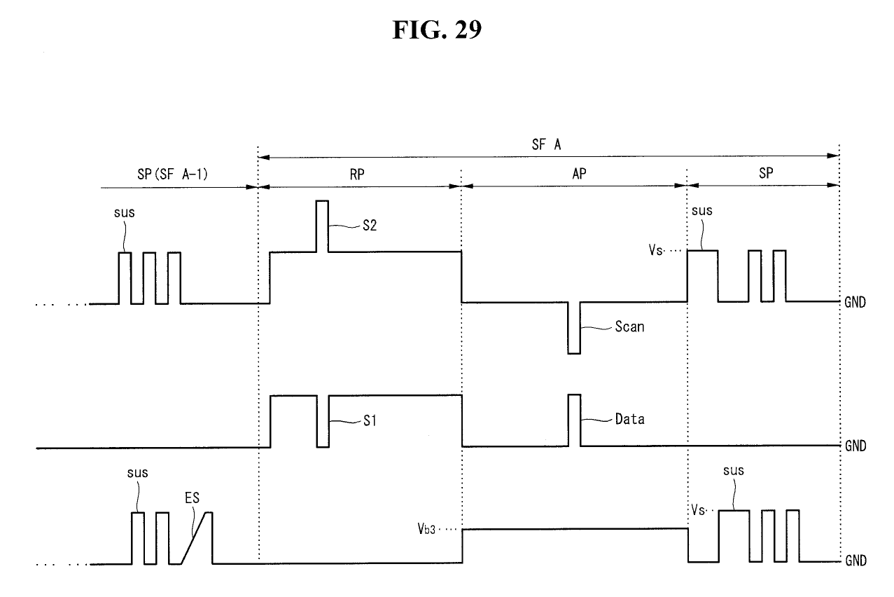

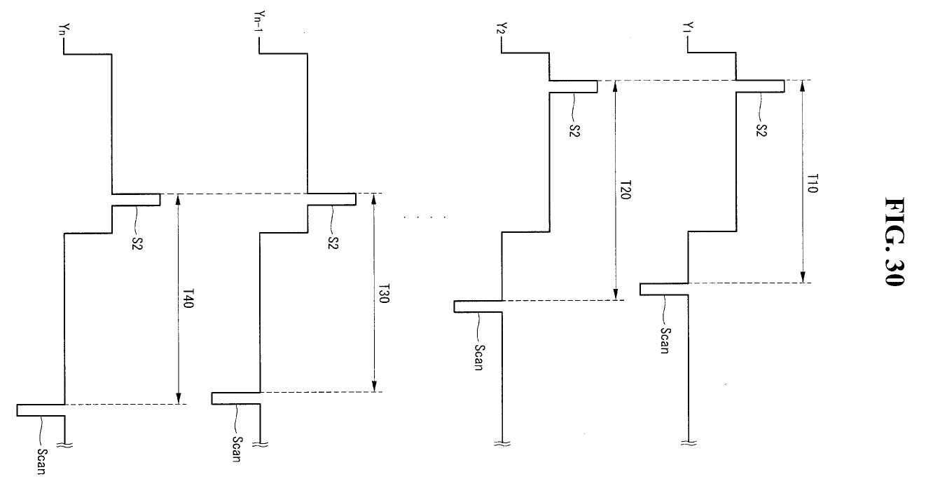

FIGS. 28 and 29 illustrate a driving signal supplied prior to a reset period; and

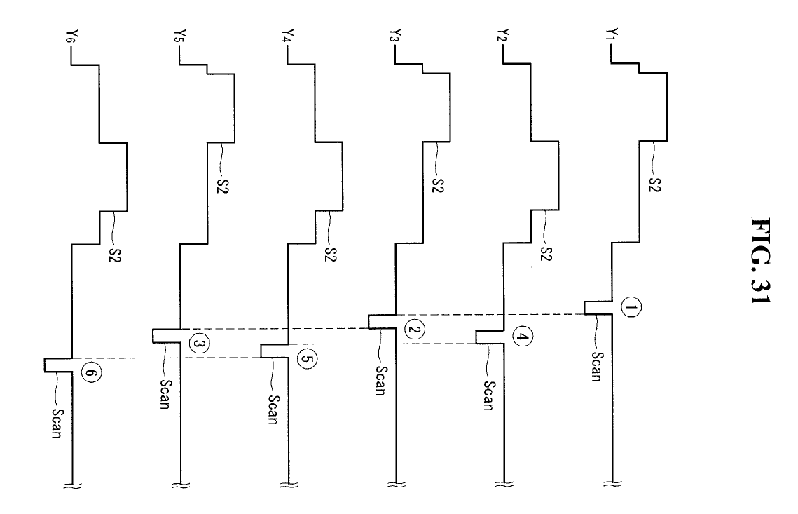

FIGS. 30 and 31 illustrate a method for supplying a second signal.

### DETAILED DESCRIPTION OF PREFERRED EMBODIMENTS

Reference will now be made in detail embodiments of the invention examples of which are illustrated in the accompanying drawings.

FIG. 1 illustrates an exemplary configuration of a plasma display apparatus according to an embodiment.

As shown in FIG. 1, the plasma display apparatus according to the embodiment includes a plasma display panel 100 and a driver 110.

The plasma display panel 100 may include scan electrodes Y1 to Yn and sustain electrodes Z1 to Zn positioned substantially parallel to each other and address electrodes X1 to Xm crossing the scan electrodes Y1 to Yn and the sustain electrodes Z1 to Zn.

The driver 110 may supply driving signals to at least one of the scan electrodes Y1 to Yn, the sustain electrodes Z1 to Zn, or the address electrodes X1 to Xm to thereby display an image on the screen of the plasma display panel 100.

Although FIG. 1 shows the driver 110 formed in the form of a signal board, the driver 110 may be formed in the form of a plurality of boards depending on the electrodes on the plasma display panel 100. For example, the driver 110 may include a first driver (not shown) for driving the scan electrodes Y1 to Yn, a second driver (not shown) for driving the sustain electrodes Z1 to Zn, and a third driver (not shown) for driving the address electrodes X1 to Xm.

FIG. 2 illustrates an exemplary structure of the plasma display panel.

As shown in FIG. 2, the plasma display panel my include a front substrate 201, on which a scan electrode 202 and a sustain electrode 203 are formed substantially parallel to each other and a rear substrate 211 on which an address electrode 213 is formed to cross the scan electrode 202 and the sustain electrode 203.

An upper dielectric layer 204 may be formed on the scan electrode 202 and the sustain electrode 203 to limit a discharge current of the scan electrode 202 and the sustain electrode 203 and to provide insulation between the scan electrode 202 and the sustain electrode 203.

A protective layer 205 may be formed on the upper dielectric layer 204 to facilitate discharge conditions. The protective layer 205 may be formed of a material having a high secondary electron emission coefficient, for example, magnesium oxide (MgO).

A lower dielectric layer 215 may be formed on the address electrode 213 to provide insulation between the address electrodes 213.

Barrier ribs 212 of a stripe type, a well type, a delta type, a honeycomb type, etc. may be formed on the lower dielectric layer 215 to partition discharge spaces (i.e., discharge cells). Hence, a first discharge cell emitting red light, a second discharge cell emitting blue light, and a third discharge cell emitting green light, etc. may be formed between the front substrate 201 and the rear substrate 211. In addition to the first, second, and third discharge cells, a fourth discharge cell emitting white light or yellow light may be further provided.

Widths of the first, second, and third discharge cells may be substantially equal to one another. Further, a width of at least one of the first, second, and third discharge cells may be different from widths of the other discharge cells. For example, the first discharge cell may have a minimum width, and widths of the second and third discharge cells may be greater than the width of the first discharge cell. The width of the second discharge cell may be substantially equal to or different from the width of the third discharge cell. Hence, a color temperature of an image displayed on the plasma display panel 100 can be improved.

The barrier rib 212 may have various structures as well as the structure shown in FIG. 2. For example, the barrier rib 212 may include first and second barrier ribs crossing each other. The barrier rib 212 may have a differential structure in which heights of the first and second barrier ribs are different from each other, a channel structure in which a channel usable as an exhaust path is formed on at least one of the first barrier rib or the second barrier rib, a hollow structure in which a hollow is formed on at least one of the first barrier rib or the second barrier rib, etc.

Although FIG. 2 shows that the first, second, and third discharge cells are arranged on the same line, the first, second, and third discharge cells may be arranged in a different pattern. For example, a delta type arrangement in which the first, second, and third discharge cells are arranged in a triangle shape may be applicable. Further, the discharge cells may have a variety of polygonal shapes such as pentagonal and hexagonal shapes as well as a rectangular shape.

Each of the discharge cells partitioned by the barrier ribs 212 may be filled with a discharge gas. The discharge gas may include xenon (Xe) and neon (Ne). The discharge gas may further include at least one of argon (Ar) and helium (He).

A phosphor layer 214 may be formed inside the discharge cells to emit visible light for an image display during an address discharge. For example, first, second, and third phosphor layers that respectively produce red, blue, and green light may be formed inside the discharge cells. In addition to the first, second, and third phosphor layers, a fourth phosphor layer generating white light and/or yellow light may be further provided.

A thickness of at least one of the first, second, and third phosphor layers may be different from thicknesses of the other phosphor layers. For instance, a thickness of the second phosphor layer or the third phosphor layer may be greater than a thickness of the first phosphor layer. The thickness of the second phosphor layer may be substantially equal or different from the thickness of the third phosphor layer.

FIG. 2 shows that the upper dielectric layer 204 and the lower dielectric layer 215 each have a single-layered structure. However, at least one of the upper dielectric layer 204 and the lower dielectric layer 215 may have a multi-layered structure.

A black layer (not shown) capable of absorbing external light may be further formed on the barrier rib 212 so as to prevent the external light from being reflected by the barrier rib 212. Further, another black layer (not shown) may be further formed at a predetermined location of the front substrate 201 corresponding to the barrier rib 212.

While the address electrode 213 may have a substantially constant width or thickness, a width or thickness of the address electrode 213 inside the discharge cell may be different from a width or thickness of the address electrode 213 outside the discharge cell. For example, a width or thickness of the address electrode 213 inside the discharge cell may be greater than a width or thickness of the address electrode 213 outside the discharge cell.

FIG. 3 illustrates a frame for achieving a gray level of an image.

As shown in FIG. 3, a frame for achieving a gray level of an image may be divided into a plurality of subfields each having a different number of emission times.

Although it is not shown, at least one of the plurality of subfields may be subdivided into a reset period for initializing the discharge cells, an address period for selecting cells to be discharged, and a sustain period for representing a gray level depending on the number of discharges.

For example, if an image with 256-gray level is to be displayed, as shown in FIG. 3, a frame may be divided into 8 subfields SF1 to SF8. Each of the 8 subfields SF1 to SF8 may be subdivided into a reset period, an address period, and a sustain period.

The number of sustain signals supplied during the sustain period may determine a gray level of each of the subfields. For example, in such a method of setting a gray level of a first subfield to 2⁰ and a gray level of a second subfield to 2¹, the sustain period increases in a ratio of 2ⁿ (where, n=0, 1, 2, 3, 4, 5, 6, 7) in each of the subfields. Hence, various gray levels of an image may be achieved by controlling the number of sustain signals supplied during the sustain period of each subfield depending on a gray level of each subfield.

Although FIG. 3 shows that one frame includes 8 subfields, the number of subfields constituting one frame may vary. For example, one frame may include 10 or 12 subfields. Further, although FIG. 3 shows the subfields of the frame arranged in increasing order of gray level weight, the subfields may be arranged in decreasing order of gray level weight, or may be arranged regardless of gray level weight.

FIG. 4 illustrates an exemplary method of driving the plasma display panel.

As shown in FIG. 4, during a reset period RP for initialization of at least one subfield of a plurality of subfields of a frame, a second signal S2 may be supplied to the scan electrode Y, and a first signal S1 corresponding to the second signal S2 may be supplied to the address electrode X. The first signal S1 may overlap the second signal S2. A reset discharge may occur in the discharge cells through a supply of the first and second signals S1 and S2. The reset discharge may allow wall charges to be uniformly distributed inside the discharge cells to be turned on. Namely, wall charges may be uniformly distributed inside the discharge cells to which the first signal S1 is supplied.

During an address period AP following the reset period RP, a scan signal Scan may be supplied to the scan electrode Y. A direction of the scan signal Scan may be opposite to a direction of the second signal S2. A data signal Data corresponding to the scan signal Scan may be supplied to the address electrode X. A direction of the data signal Data may be opposite to a direction of the first signal S1. An address discharge may occur inside the discharge cell, to which the data signal Data is supplied, due to a voltage difference between the scan signal Scan and the data signal Data. A third bias voltage Vb3 may be supplied to the sustain electrode Z so as to prevent the address discharge from unstably occurring because of the sustain electrode Z.

A pulse width of a scan signal supplied to the scan electrode during an address period of at least one subfield of a plurality of subfields may be different from pulse widths of negative polarity signals in other subfields. A pulse width of a scan signal in a subfield may be greater than a pulse width of a scan signal in a next subfield in time order. For example, a pulse width of the scan signal may be gradually reduced in order of 2.6 μs, 2.3 μs, 2.1 μs, 1.9 μs, etc., or may be reduced in order of 2.6 μs, 2.3 μs, 2.3 μs, 2.1 μs, . . . , 1.9 μs, 1.9 μs, etc. in the successively arranged subfields.

During a sustain period SP following the address period AP, a sustain signal sus may be supplied to at least one of the scan electrode Y or the sustain electrode Z. For example, the sustain signals sus may be alternately supplied to the scan electrode Y and the sustain electrode Z. As a wall voltage inside the discharge cell selected by performing the address discharge is added to a sustain voltage Vs of the sustain signal sus, every time the sustain signal sus is supplied, a sustain discharge, i.e., a display discharge may occur between the scan electrode Y and the sustain electrode Z.

FIGS. 5 to 7 illustrate an exemplary method of driving the plasma display panel during a reset period.

As shown in FIG. 5, the second signals S2 may be sequentially supplied to the first to n-th scan electrodes Y1 to Yn. Namely, application time points of the second signals S2 may be different from one another.

The first signal S1 corresponding to the second signal S2 may be supplied to the plurality of address electrodes X at the substantially same application time point. For example, when the second signal S2 is supplied to the first scan electrode Y1, the first signals S1 may be simultaneously supplied to the plurality of address electrodes X. Further, when the second signal S2 is supplied to the n-th scan electrode Yn, the first signals S1 may be simultaneously supplied to the plurality of address electrodes X.

The first signal S1 may be selectively supplied to the discharge cells to receive the data signal Data. Namely, a reset operation may be performed using the same method as an addressing method.

For example, as shown in (a) of FIG. 6, when the data signal Data is supplied to the address electrode X during an address period, the first signal S1 is supplied to the address electrode X during a reset period prior to the address period. On the other hand, as shown in (b) of FIG. 6, when the data signal Data is not supplied during an address period (i.e., when an address discharge does not occurs), the first signal S1 is not supplied during a reset period prior to the address period.

In other words, a reset discharge may occur in the discharge cell, in which an address discharge will occur, due to the first and second signals S1 and S2. On the other hand, a reset discharge may not occur in the discharge cell, in which an address discharge will not occur, because the first signal S1 is not supplied.

As above, an amount of light generated by a reset discharge may be reduced by selectively supplying the first signal S1 in the discharge cell, in which an address discharge will occur. Hence, a dark luminance may be reduced, and contrast characteristic may be improved.

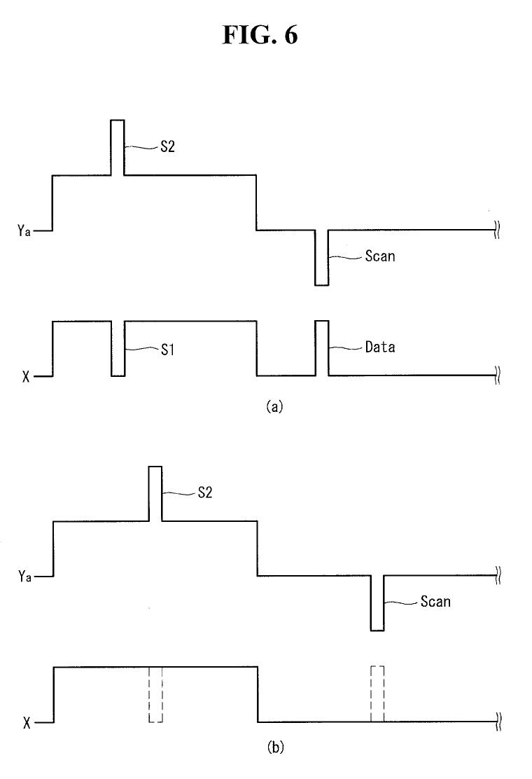

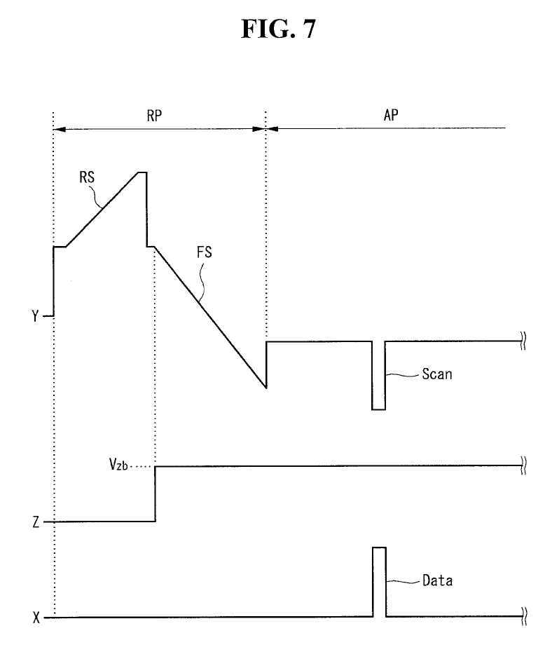

FIG. 7 shows that a rising signal PS with a gradually rising voltage and a falling signal FS with a gradually falling voltage are supplied to the scan electrode Y during a reset period RP.

In FIG. 7, a reset discharge may occur in all the discharge cells using the rising signal RS and the falling signal FS irrespective of an occurrence of an address discharge. Hence, wall charges may be uniformly distributed in all the discharge cells.

As shown in FIG. 7, in case the reset discharge occurs in all the discharge cells irrespective of the occurrence of the address discharge, an amount of light generated during the reset period may excessively increase. Hence, the dark luminance may excessively increase, and the contrast characteristic may worsen. On the other hand, as shown in FIGS. 4 to 6, in case the reset discharge selectively occurs by selectively supplying the first signal S1 in the discharge cells to generate the address discharge, the dark luminance may be remarkably reduced, and the contrast characteristic may be improved.

A voltage magnitude ΔV1 of the first signal S1 may be substantially equal to a voltage magnitude ΔV2 of the data signal Data. In this case, because the first signal S1 is generated using a voltage circuit generating the data signal Data, a separate voltage circuit for the first signal S1 is not necessary. Hence, a simplicity of the circuit and a reduction in the manufacturing cost may be achieved.

During the reset period, a first bias voltage Vb1 greater than a ground level voltage GND may be supplied to the plurality of address electrodes X. The first signal S1 may start from the first bias voltage Vb1.

As above, when the first bias voltage Vb1 and the first signal S1 starting from the first bias voltage Vb1 are subsequently supplied to the address electrodes during the reset period, it may be advantageous that a voltage difference between the scan electrode and the address electrode during the reset period is set to a value suitable for the reset discharge. Hence, the rest discharge may be stabilized.

The first bias voltage Vb1 may be substantially equal to a maximum voltage Vd of the data signal Data. The first bias voltage Vb1 may be generated using the voltage circuit generating the data signal Data.

A voltage magnitude ΔV3 of the second signal S2 may be substantially equal to a voltage magnitude ΔV4 of the scan signal Scan. In this case, because the second signal S2 is generated using a voltage circuit generating the scan signal Scan, a separate voltage circuit for the second signal S2 is not necessary. Hence, a simplicity of the circuit and a reduction in the manufacturing cost may be achieved.

During the reset period, a second bias voltage Vb2 greater than the ground level voltage GND may be supplied to the plurality of scan electrodes Y. The second signal S2 may start from the second bias voltage Vb2.

As above, when the second bias voltage Vb2 and the second signal S2 starting from the first bias voltage Vb1 are subsequently supplied to the scan electrodes Y during the reset period, it may be advantageous in the reset discharge by relatively increasing a voltage difference between the scan electrode and the address electrode during the reset period. Hence, the rest discharge may be stabilized.

The second bias voltage Vb2 may be substantially equal to a maximum voltage Vs of the sustain signal sus. The second bias voltage Vb2 may be generated using a voltage circuit generating the sustain signal sus.

FIGS. 8 to 10 illustrate another form of the first signal S1.

As shown in FIG. 8, the voltage magnitude ΔV1 of the first signal S1 may be greater than the voltage magnitude ΔV2 of the data signal Data, and the first bias voltage Vb1 may be higher than the maximum voltage Vd of the data signal Data. In this case, an intensity of the reset discharge occurring between the scan electrode and the address electrode further increases, and thus the reset operation can be certainly performed. A pulse width W1 of the first signal S1 may be substantially equal to or different from a pulse width W2 of the data signal Data.

As shown in FIG. 9, the first bias voltage Vb1 may be lower than the maximum voltage Vd of the data signal Data.

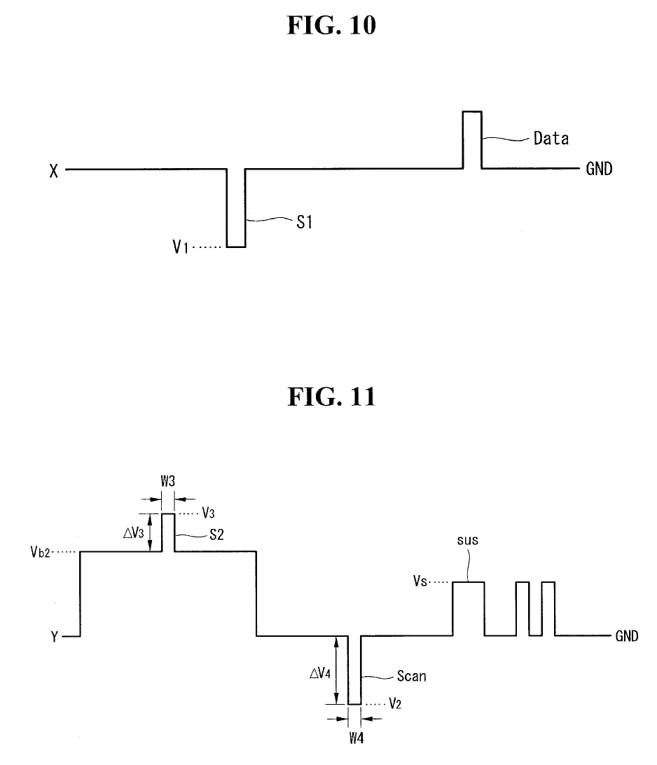

As shown in FIG. 10, the first signal S1 my start from the ground level voltage GND. Namely, a supply of the first bias voltage Vb1 may be omitted during the reset period.

FIGS. 11 to 13 illustrate another form of the second signal S2.

As shown in FIG. 11, the second bias voltage Vb2 may be higher than the maximum voltage Vs of the sustain signal sus. In this case, the voltage magnitude ΔV3 of the second signal S2 may be smaller than the voltage magnitude ΔV4 of the scan signal Scan or may be smaller than a voltage magnitude of the sustain signal sus. A pulse width W3 of the second signal S2 may be substantially equal to or different from a pulse width W4 of the scan signal Scan.

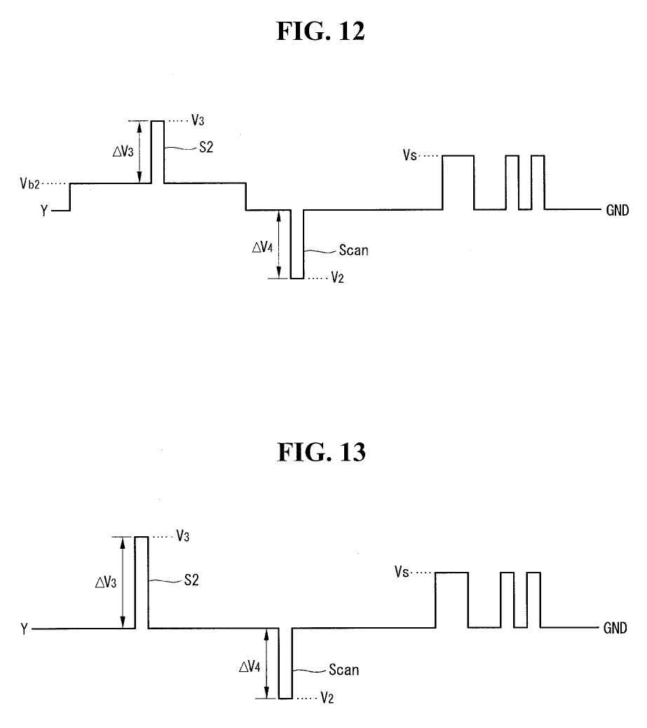

As shown in FIG. 12, the second bias voltage Vb2 may be lower than the maximum voltage Vs of the sustain signal sus.

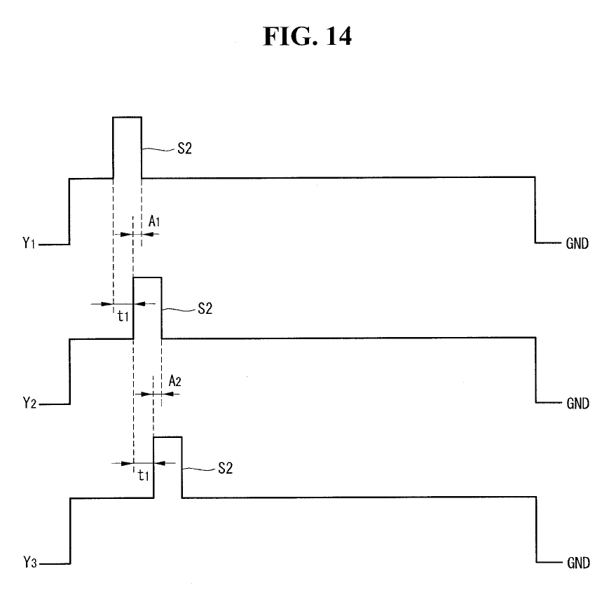

As shown in FIG. 13, the second signal S2 may start from the ground level voltage GND. Namely, a supply of the second bias voltage Vb2 may be omitted during the reset period. In this case, the voltage magnitude ΔV3 of the second signal S2 may be greater than the voltage magnitude ΔV4 of the scan signal Scan or may be greater than a voltage magnitude of the sustain signal sus.

FIGS. 14 and 15 illustrate a relationship between two successively supplied second signals.

As shown in FIG. 14, the second signals S2 supplied to two successively positioned scan electrodes among the plurality of scan electrodes may partially overlap each other. For example, if the plurality of scan electrodes successively include first, second, and third scan electrodes Y1, Y2, and Y3, the second signals S2 supplied to the successively positioned first and second scan electrodes Y1 and Y2 may partially overlap each other by a portion A1, and the second signals S2 supplied to the successively positioned second and third scan electrodes Y2 and Y3 may partially overlap each other by a portion A2. A magnitude of the portion A1 may be substantially equal to or different from a magnitude of the portion A2.

A difference between supply time points of the second signals S2 supplied to two successively positioned scan electrodes among the plurality of scan electrodes may be substantially equal to a difference between supply time points of the second signals S2 supplied to another two successively positioned scan electrodes. For example, if the second signals S2 are sequentially supplied to the first, second, and third scan electrodes Y1, Y2, and Y3, a difference t1 between a supply time point of the second signal S2 supplied to the first scan electrode Y1 and a supply time point of the second signal S2 supplied to the second scan electrode Y2 may be substantially equal to a difference t1 between a supply time point of the second signal S2 supplied to the second scan electrode Y2 and a supply time point of the second signal S2 supplied to the third scan electrode Y3.

As shown in FIG. 15, the second signals S2 may be successively supplied to two successively positioned scan electrodes among the plurality of scan electrodes at a predetermined time interval. For example, the second signals S2 may be successively supplied to the successively positioned first and second scan electrodes Y1 and Y2 by at a time interval A3. Namely, a supply ending time point of the second signal S2 supplied to the first scan electrode Y1 may be earlier than a supply start time point of the second signal S2 supplied to the second scan electrode Y2 by the time interval A3. The second signals S2 may be successively supplied to the successively positioned second and third scan electrodes Y2 and Y3 by at a time interval A4. In FIG. 15, the time interval A3 may be substantially equal to or different from the time interval A4.

Further, if the second signals S2 are sequentially supplied to the first, second, and third scan electrodes Y1, Y2, and Y3, a difference t2 between a supply time point of the second signal S2 supplied to the first scan electrode Y1 and a supply time point of the second signal S2 supplied to the second scan electrode Y2 may be substantially equal to a difference t2 between a supply time point of the second signal S2 supplied to the second scan electrode Y2 and a supply time point of the second signal S2 supplied to the third scan electrode Y3.

FIGS. 16 and 17 illustrate a relationship between the second signal and the scan signal.

As shown in FIG. 16, a difference between supply time points of the second signal S2 and the scan signal Scan supplied to one scan electrode of the plurality of scan electrodes may be substantially equal to a difference between supply time points of the second signal S2 and the scan signal Scan supplied to another scan electrode. For example, a difference T1 between supply time points of the second signal S2 and the scan signal Scan supplied to the first scan electrode Y1 may be substantially equal to a difference T2 between supply time points of the second signal S2 and the scan signal Scan supplied to the second scan electrode Y2 and a difference Tn between supply time points of the second signal S2 and the scan signal Scan supplied to the n-th scan electrode Yn. Hence, wall charges may be uniformly distributed from after the generation of the reset discharge to the generation of an address discharge. As a result, an address discharge may be uniformly distributed in the discharge cells.

As shown in FIG. 17, a supply order of the second signals S2 supplied to the scan electrodes Y1 to Yn may be the n-th scan electrode Yn, the (n−1)-th scan electrode Y(n−1), . . . , the second scan electrode Y2, and the first scan electrode Y1. Namely, the supply order of the second signals S2 may be reversed to an arrangement order of the scan electrodes Y1 to Yn. In this case, a difference T10 between supply time points of the second signal S2 and the scan signal Scan supplied to the first scan electrode Y1 may be substantially equal to a difference T11 between supply time points of the second signal S2 and the scan signal Scan supplied to the second scan electrode Y2 and a difference T12 between supply time points of the second signal S2 and the scan signal Scan supplied to the n-th scan electrode Yn.

FIG. 18 illustrates an exemplary method of adjusting a supply order of the second signal.

As shown in FIG. 18, the second signals S2 may be sequentially supplied to two non-adjacent scan electrodes among the plurality of scan electrodes. For example, the second signals S2 may be supplied in order of the scan electrodes Y1, Y3, Y5, Y2, Y4, and Y6. FIG. 18 shows a supply order of the second signal S2 or a supply order of the scan signal Scan using a numeral.

As above, the number of switching operations of a switching element may be reduced by adjusting the supply order of the second signal S2. Hence, a noise and electromagnetic interference (EMI) may be reduced and an electrical damage of the switching element may be prevented. For example, it is assumed that first to sixth discharge cells are positioned in an arrangement order of the scan electrodes Y1 to Y6, the first, third, and fifth discharge cells are turned on, and the second, fourth, and sixth discharge cells are turned off. In this case, the second signals S2 are sequentially supplied to the 6 scan electrodes Y1 to Y6, 6 switching operations are performed to supply the data signal. On the other hand, if the second signals S2 are supplied in order of the scan electrodes Y1, Y3, Y5, Y2, Y4, and Y6, 2 switching operations are performed to supply the data signal.

FIG. 18 illustrates that the second signals S2 are sequentially supplied to the odd-numbered scan electrodes and then are sequentially supplied to the even-numbered scan electrodes. The second signals S2 may be sequentially supplied to 3n-th (where n is an integer greater than 0) scan electrodes and then may be sequentially supplied to (3n+1)-th scan electrodes. Finally, the second signals S2 may be sequentially supplied to (3n+2)-th scan electrodes. In this case, as shown in FIGS. 16 and 17, a difference between supply time points of the second signal S2 and the scan signal Scan supplied to one scan electrode of the plurality of scan electrodes may be substantially equal to a difference between supply time points of the second signal S2 and the scan signal Scan supplied to another scan electrode.

FIGS. 19 and 23 illustrate a selective write subfield and a selective erase subfield.

As shown in FIG. 19, at least one of a plurality of subfields of a frame may be a selective write subfield, and at least one of the other subfields may be a selective erase subfield.

In case a frame includes a total of 8 subfields SF1 to SF8, the first subfield SF1 is called a first part, and the second to eighth subfields SF2 to SF8 are called a second part, the first part may be a selective write subfield, and the second part may include at least one selective erase subfield.

Preferably, in the frame, all the selective erase subfields may follow at least one selective write subfield. For example, if the first subfield SF1 is a selective write subfield, the second to eighth subfields SF2 to SF8 may be selective erase subfields.

During a reset period of at least one selective write subfield, the first signal S1 may be supplied to at least one address electrode to which the data signal will be supplied, and the second signal S2 may be supplied to the plurality of scan electrodes.

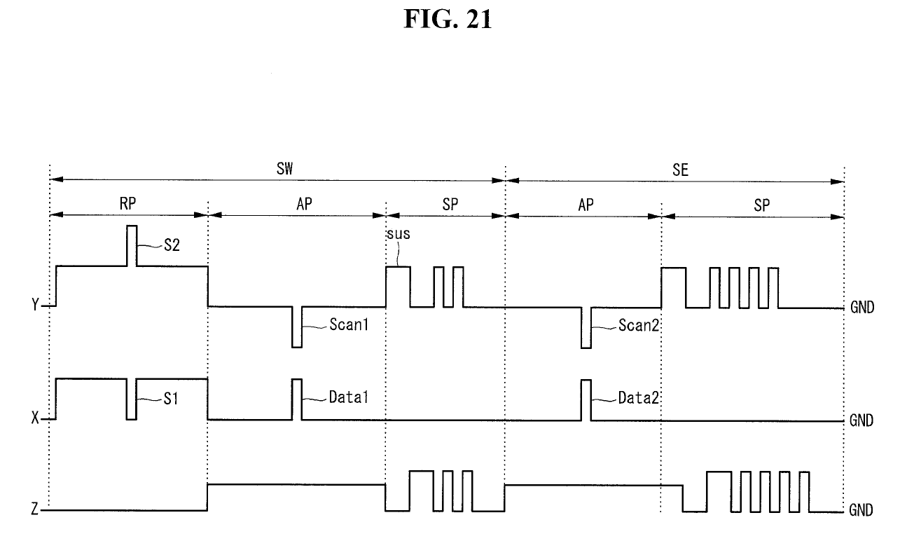

For example, as shown in FIG. 21, during a reset period RP of a selective write subfield SW, the second signal S2 may be supplied to the scan electrode Y, and the first signal S1 may be supplied to the address electrode X. Hence, a reset discharge may occur. Because a reset period is omitted in a selective erase subfield SE, a supply of the first and second signals S1 and S2 may be omitted.

As above, a dark luminance may be reduced and insufficiency of driving time resulting from the supply of the first and second signals S1 and S2 may be compensated for while improving the contrast characteristics by performing a reset operation using the first and second signals S1 and S2 in at least one selective write subfield and omitting a supply of the first and second signals S1 and S2 in a selective erase subfield.

In a selective write subfield, the discharge cell to which the scan signal is supplied during an address period may be turned on during a sustain period following the address period. More specifically, in a selective write subfield, all the discharge cells are turned off during a reset period, and then the discharge cells selected by generating an address discharge are turned on during an address period. Subsequently, a sustain discharge occurs inside the selected discharge cells during a sustain period to thereby display an image.

In a selective erase subfield, the discharge cell to which a scan signal is supplied during an address period may be turned off during a sustain period following the address period. More specifically, in a selective erase subfield, all the discharge cells are turned on during a reset period, and then the discharge cells selected by generating an address discharge are turned off during an address period. Subsequently, a sustain discharge occurs inside the non-selected discharge cells during a sustain period to thereby display an image.

Because the discharge cells to be turned on during the sustain period have to be selected during the address period of the selective write subfield, a sufficient amount of wall charges have to be accumulated during the address discharge. Accordingly, it may be preferable that a pulse width of the scan signal supplied during the address period of the selective write subfield is sufficiently wide.

On the other hand, because the discharge cells to be turned off during the sustain period have to be selected during the address period of the selective erase subfield, a sufficient amount of wall charges have to be erased during the address discharge. Accordingly, it may be preferable that a pulse width of the scan signal supplied during the address period of the selective erase subfield is sufficiently narrow.

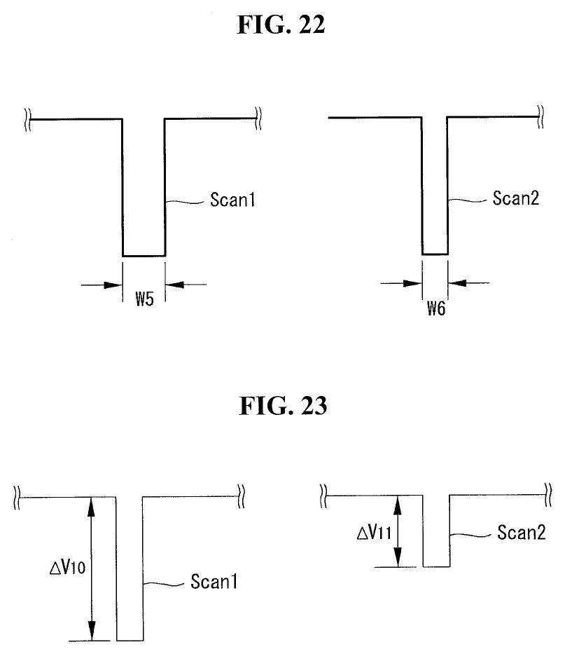

As shown in FIGS. 21 and 22, a pulse width W6 of a scan signal Scan2 supplied during an address period of a selective erase subfield may be smaller than a pulse width w5 of a scan signal Scan1 supplied during an address period of a selective write subfield.

As shown in FIG. 23, a voltage magnitude Δ11 of a scan signal Scan2 supplied during an address period of a selective erase subfield may be smaller than a voltage magnitude of Δ10 of a scan signal Scan1 supplied during an address period of a selective write subfield.

Although it is not shown, at least one of a voltage magnitude and a pulse width of a data signal supplied during an address period of a selective erase subfield may be smaller than a voltage magnitude and a pulse width of a data signal supplied during an address period of a selective write subfield.

Because discharge cells to be turned off have to be selected in a selective erase subfield, a selective erase subfield may be turned on by turning on a previous subfield of the selective erase subfield. Because the discharge cells to be turned off are selected from on-discharge cells in the previous subfield, a reset period may be omitted in the selective erase subfield. Namely, a supply of the first and second signals S1 and S2 may be omitted in the selective erase subfield.

FIG. 20 illustrates a method of achieving a gray scale using a selective write subfield and a selective erase subfield.

In FIG. 20, it is assumed that a gray level of each subfield increases in a ratio of 2ⁿ (where, n=0, 1, 2, 3, 4, 5, 6, 7) using a method of setting a gray level of a first subfield SF1 to 2⁰ and a gray level of a second subfield SF2 to 2¹. Further, it is assumed that the first subfield SF1 is a selective write subfield and the second to eighth subfields SF2 to SF8 are selective erase subfields.

Although FIG. 20 shows that one frame includes 8 subfields, the number of subfields constituting one frame may vary. For example, one frame may include 10 or 12 subfields.

In FIG. 20, a gray level of 0 is achieved by turning off all the subfields.

A gray level of 1 is achieved by turning on the first subfield SF1 and turning off the other subfields SF2 to SF8. In this case, because the second to eighth subfields SF2 to SF8 being the selective erase subfield are turned off, an erase address discharge occurs by supplying the data signal to the address electrode during an address period of the second subfield SF2.

A gray level of 3 is achieved by turning on the first and second subfields SF1 and SF2. In the gray level of 3, because the second subfield SF2 has to be turned on and the third to eighth subfields SF3 to SF8 have to be turned off in the gray level of 3, an erase address discharge occurs in the third subfield SF3 by not supplying the data signal in the second subfield and supplying the data signal in the third subfield SF3. A gray level of 7 is achieved by turning on the first to third subfields SF1 to SF3, and a gray level of 15 is achieved by turning on the first to fourth subfields SF1 to SF4.

A gray level of 31 is achieved by turning on the first to fifth subfields SF1 to SF5, a gray level of 63 is achieved by turning on the first to sixth subfields SF1 to SF6, a gray level of 127 is achieved by turning on the first to seventh subfields SF1 to SF7, and a gray level of 255 is achieved by turning on all the subfields SF1 to SF8.

In the method illustrated in FIG. 20, a gray scale having 9 values may be achieved.

As above, if a frame includes a selective erase subfield (i.e., the second to eighth subfields), an incremental coding method, in which subfields constituting the frame are sequentially selected according to position order, may be used.

A reason why one frame includes at least one selective write subfield and at least one selective erase subfield is described below.

As described above, a pulse width of the scan signal in a selective erase subfield may be smaller than a pulse width of the scan signal in a selective write subfield, and a reset period may be omitted in the selective erase subfield. Therefore, a length of the selective erase subfield may be shorter than a length of the selective erase subfield.

Accordingly, if one frame includes only selective erase subfields, the number of subfields constituting one frame may increase, and thus a false contour noise may be prevented. On the other hand, if one frame includes only selective erase subfields, all of discharge cells have to be turned on in a first arranged subfield among the selective erase subfields. Therefore, a black luminance may increase, and contrast characteristic may worsen.

If one frame includes only selective write subfields, only on-discharge cells are selected during an address period, and the selected discharge cells are turned on during a sustain period. Namely, because only the selected discharge cells are turned on in an off-state of all of discharge cells, the contrast characteristic may sufficiently increase. On the other hand, if one frame includes only selective write subfields, each of all the selective write subfields has to include a reset period. Therefore, the number of subfields constituting one frame may decrease, and a false contour noise may increase.

If one frame includes at least one selective write subfield and at least one selective erase subfield, an image is displayed in one frame by arranging the selective write subfield prior to the selective erase subfield and turning off the discharge cell selected in the selective write subfield in the selective erase subfield following the selective write subfield. In this case, because discharge cells selectively turned on in a selective write subfield may be selectively turned off in a selective erase subfield without turning on all of discharge cells, contrast characteristics may be improved. Because a reset period may be omitted in the selective erase subfield, the number of subfields constituting one frame may increase.

In other words, when one frame includes at least one selective write subfield and at least one selective erase subfield, the number of subfields constituting one frame may increase, the false contour noise may be prevented, and the contrast characteristics may be improved.

When the first and second signals are supplied in at least one selective write subfield and a supply of the first and second signals is omitted in the selective erase subfield, a dark luminance may be reduced and insufficiency of driving time resulting from the supply of the first and second signals may be compensated for while improving the contrast characteristics.

FIG. 24 illustrates a fourth bias voltage.

As shown in FIG. 24, a fourth bias voltage Vb4 lower than the ground level voltage GND may be supplied to the scan electrode during an address period. A scan signal Scan may start from the fourth bias voltage Vb4. A supply of the fourth bias voltage Vb4 may easily increase a voltage difference between the scan electrode and the address electrode during an address period, and thus an address discharge may be further stabilized.

FIGS. 25 and 26 illustrate another form of the first and second signals.

As shown in FIG. 25, a first signal S1 may gradually fall in the form of an exponential function, and a second signal S2 may gradually rise in the form of an exponential function.

As shown in FIG. 26, a first signal S1 may be a falling ramp signal with a gradually falling voltage, and a second signal S2 may be a rising ramp signal with a gradually rising voltage. In this case, the contrast characteristic may be improved by preventing an intensity of a reset discharge generated by the first and second signals S1 and S2 from excessively increasing.

FIG. 27 illustrates a signal supplied between a reset period and an address period.

As shown in FIG. 27, a third signal S3 may be supplied to the scan electrode during a predetermined time of period between a reset period and an address period. The third signal S3 may be supplied between the second signal S2 and the scan signal Scan. A supply of the third signal S3 partially erases a large amount of wall charges excessively accumulated during the reset period to thereby prevent an erroneous discharge from occurring during the address period and a sustain period.

FIG. 27 shows that the third signal S3 is supplied to only the scan electrode. However, the third signal S3 may be supplied to the sustain electrode or the address electrode.

FIGS. 28 and 29 illustrate a driving signal supplied prior to a reset period.

As shown in FIG. 28, during a pre-reset period PRP prior to a reset period RP, a fourth signal S4 with a gradually falling voltage may be supplied to the scan electrode Y, and a fifth signal 5S corresponding to the fourth signal S4 may be supplied to the sustain electrode Z. The fifth signal S5 may be uniformly kept at a voltage V10. A sufficient amount of wall charges may be previously accumulated in the discharge cells prior to the reset period RP by supplying the fourth and fifth signals S4 and S5 during the pre-reset period PRP. Hence, a voltage magnitude of the first signal S1 or the second signal S2 may be reduced. Further, a driving efficiency may be improved, an intensity of a reset discharge may be reduced while generating a stable reset discharge, and the contrast characteristic may be improved.

As shown in FIG. 29, an erase signal ES may be supplied to at least one of the scan electrode and the sustain electrode prior to a reset period RP. For example, in case the first and second signals S1 and S2 are supplied during a reset period RP of a subfield SFA, after a last sustain signal is supplied in a subfield (SFA-1) prior to the subfield SFA, an erase signal ES may be supplied to at least one of the scan electrode and the sustain electrode. Hence, wall charges may be uniformly erased at an end of the sustain period, and a reset discharge during the reset period RP of the subfield SFA may be stabilized.

FIGS. 30 and 31 illustrate another method for supplying the second signal.

As shown in FIG. 30, the second signal S2 may be supplied to at least two scan electrodes of the plurality of scan electrodes at the substantially same time point. In this case, the first signal S1 may be selectively supplied to the address electrodes, to which the data signal will be supplied during an address period.

For example, as shown in FIG. 30, the second signal S2 may be supplied to first and second scan electrodes Y1 and Y2 at the same time point.

In this case, a difference between supply time points of the second signal and the scan signal supplied to one scan electrode may be different from a difference between supply time points of the second signal and the scan signal supplied to another scan electrode. More specifically, a difference T10 between supply time points of the second signal S2 and the scan signal Scan supplied to the first scan electrode Y1 may be smaller than a difference T20 between supply time points of the second signal S2 and the scan signal Scan supplied to the second scan electrode Y2.

As above, when the second signal S2 is supplied to at least two scan electrodes of the plurality of scan electrodes at the substantially same time point, a simple driving operation may be performed.

As shown in FIG. 31, the second signal S2 may be supplied to the odd-numbered scan electrodes at the same time point, and the second signal S2 may be supplied to the even-numbered scan electrodes at the same time point. In this case, the second signal S2 may be supplied to the scan electrodes Y1 to Y6 in order of the scan electrodes Y1, Y3, Y5, Y2, Y4, and Y6. A pulse width of the second signal S2 illustrated in FIG. 31 may be greater than a pulse width of the second signal S2 illustrated in FIG. 18.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of driving a plasma display panel including a plurality of scan electrodes, a plurality of sustain electrodes, and a plurality of address electrodes, the method comprising:
supplying a data signal to at least one of the plurality of address electrodes during an address period of at least one subfield of a plurality of subfields; and
supplying a first signal opposite a direction of the data signal to at least one of the plurality of address electrodes, to which the data signal will be supplied, during a reset period prior to the address period.

2. The method of claim 1, wherein a voltage magnitude of the first signal is substantially equal to a voltage magnitude of the data signal.

3. The method of claim 1, wherein a first bias voltage higher than a ground level voltage is supplied to the plurality of address electrodes during the reset period,
wherein the first signal starts from the first bias voltage.

4. The method of claim 3, wherein the first bias voltage is substantially equal to a maximum voltage of the data signal.

5. The method of claim 1, wherein the first signal is not supplied to at least one address electrode of the plurality of address electrodes, to which the data signal will not be supplied.

6. The method of claim 1, further comprising:
supplying a scan signal corresponding to the data signal to the plurality of scan electrodes during the address period; and
supplying a second signal corresponding to the first signal and opposite a direction of the scan signal to the plurality of scan electrodes during the reset period.

7. The method of claim 6, wherein a second bias voltage higher than a ground level voltage is supplied to the plurality of scan electrodes during the reset period,
wherein the second signal starts from the second bias voltage.

8. The method of claim 7, wherein the second bias voltage is substantially equal to a maximum voltage of a sustain signal supplied to at least one of the scan electrode and the sustain electrode during a sustain period following the address period.

9. The method of claim 6, wherein a voltage magnitude of the second signal is substantially equal to a voltage magnitude of the scan signal.

10. The method of claim 6, wherein the plurality of scan electrodes include first, second, and third scan electrodes,
wherein a supply time point of the second signal supplied to the first scan electrode, a supply time point of the second signal supplied to the second scan electrode, and a supply time point of the second signal supplied to the third scan electrode are different from one another.

11. The method of claim 10, wherein the second signals are sequentially supplied to the first, second, and third scan electrodes,
wherein a difference between the supply time points of the second signals supplied to the first and second scan electrodes is substantially equal to a difference between the supply time points of the second signals supplied to the second and third scan electrodes.

12. The method of claim 10, wherein a difference between supply time points of the second signal and the scan signal supplied to the first scan electrode, a difference between supply time points of the second signal and the scan signal supplied to the second scan electrode, and a difference between supply time points of the second signal and the scan signal supplied to the third scan electrode are substantially equal to one another.

13. The method of claim 6, wherein the second signals supplied to two successively scanned scan electrodes of the plurality of scan electrodes partially overlap each other.

14. The method of claim 6, wherein the second signals are supplied to two successively scanned scan electrodes of the plurality of scan electrodes at a predetermined time interval.

15. A method of driving a plasma display panel including a plurality of scan electrodes, a plurality of sustain electrodes, and a plurality of address electrodes, the method comprising:
supplying scan signals to the plurality of scan electrodes during an address period of at least one subfield of a plurality of subfields;
supplying second signals opposite a direction of the scan signals to the plurality of scan electrodes during a reset period prior to the address period;
sequentially supplying the scan signals to two non-adjacent scan electrodes of the plurality of scan electrodes; and
sequentially supplying the second signals to two non-adjacent scan electrodes of the plurality of scan electrodes.

16. The method of claim 15, wherein the plurality of scan electrodes include first, second, and third scan electrodes,
wherein the second scan electrode is positioned between the first and third scan electrodes, and the scan signals are sequentially supplied to the first and third scan electrodes,
wherein a difference between supply time points of the second signal and the scan signal supplied to the first scan electrode, a difference between supply time points of the second signal and the scan signal supplied to the second scan electrode, and a difference between supply time points of the second signal and the scan signal supplied to the third scan electrode are substantially equal to one another.

17. The method of claim 15, further comprising:
supplying a data signal corresponding to the scan signal to at least one of the plurality of address electrodes; and
supplying a first signal corresponding to the second signal to at least one address electrode of the plurality of address electrodes, to which the data signal will be supplied, during the reset period.

18. A method of driving a plasma display panel including a plurality of scan electrodes, a plurality of sustain electrodes, and a plurality of address electrodes, the method comprising:
supplying a scan signal to the plurality of scan electrodes and supplying a data signal corresponding to the scan signal to at least one of the plurality of address electrodes during an address period of at least one selective write subfield of a plurality of subfields of a frame, at least one of remaining subfields excluding the at least one selective write subfield from the plurality of subfields being a selective erase subfield; and
supplying a first signal opposite a direction of the data signal to at least one of the plurality of address electrodes, to which the data signal will be supplied, and supplying a second signal opposite a direction of the scan signal to the plurality of scan electrodes during a reset period prior to the address period.

19. The method of claim 18, wherein the at least one selective write subfield is at least one of first to third subfields of the plurality of subfields according to arrangement order of the subfields.

20. The method of claim 18, wherein at least one of a voltage magnitude or a pulse width of the scan signal supplied to the scan electrode during the address period of the at least one selective write subfield is greater than at least one of a voltage magnitude or a pulse width of the scan signal supplied to the scan electrode during an address period of the selective erase subfield.
